(19) United States
(12) Patent Application Publication
(10) Pub. No.: US 2010/0037838 A1
(43) Pub. Date: Feb. 18, 2010

(54) VALVE FOR CONTROLLING VOLUMETRIC FLOWS

(76) Inventors: Jochen Moench, Sinzheim (DE); Alois Hils, Sasbach (DE); Georg Reeb, Buehl Eisental (DE); Roland Schmidt, Buehl (DE); Sven Urlaub, Lichtenau (DE)

Correspondence Address: MICHAEL J. STRIKER, 103 EAST NECK ROAD, HUNTINGTON, NY, 11743, US

(21) Appl. No.: 12/443,907

(22) PCT Filed: Oct. 1, 2007
(86) PCT No.: PCT/EP07/60371

§ 371 Date: Apr. 1, 2009

(30) Foreign Application Priority Data
Nov. 13, 2006 (DE) 10 2006 053 307.0

(51) Int. Cl. F01P 7/14; F16K 31/04; F16K 31/02; F16K 11/074

(52) U.S. Cl. 123/41.08; 137/487.5; 251/129.01; 137/625.46

(57) ABSTRACT

The invention relates to a valve for controlling volumetric flows in a heating and/or cooling system of a motor vehicle, comprising a valve housing (10), from which at least one inlet channel (18) and at least one outlet channel (20, 22) branch, in addition to at least one disc-type valve body (28) for controlling the flow, said body being located in the valve housing (10) so that it can rotate about the axis (31) of a driven shaft (30). According to the invention, the valve comprises means for compensating an imbalance, said means ensuring a uniform distribution of mass about the rotational axis (31) of the valve body (28). The invention also relates to a heating and/or cooling circuit (110) of motor vehicle, comprising at least one coolant control valve (131) of this type.

The present invention relates to a valve for controlling volumetric flows, in particular a coolant control valve for an internal combustion engine, according to the preamble of claim 1.

### BACKGROUND INFORMATION

A cooling and/or heating circuit of a motor vehicle typically includes a heat source to be cooled, e.g. a vehicle motor, which is to be cooled using a coolant via free or forced convection. The temperature difference across the heat source depends on the heat input and the magnitude of the volumetric flow of the coolant, while the absolute temperature of the coolant is determined via the heat input from the heat source, the heat dissipation via radiator elements which may be located in the cooling circuit, and via the heat capacities of the materials involved.

To protect the internal combustion engine of a motor vehicle from overheating, and to be able to utilize the waste heat from the internal combustion engine, e.g. to heat the passenger compartment, a coolant is circulated in motor vehicles, which may absorb the excess heat energy of the engine and remove it to a desired extent. The heating and/or cooling circuit of a motor vehicle typically includes various secondary circuits, e.g. a radiator branch, a bypass branch, and/or a heat-exchanger branch. The excess heat quantity of the coolant may be given off to the surrounding air via a radiator which is located in the radiator branch. A heat exchanger also makes it possible to utilize the available heat quantity of the coolant to heat the passenger compartment.

The distribution of the coolant flow to the various branches of a cooling and/or heating circuit of a motor vehicle is controlled via at least one valve. The desired coolant temperature is adjusted by mixing a cooled coolant flow and an uncooled coolant flow.

The regulation of the mixing ratio between the radiator branch and the bypass branch has typically been carried out using a thermostat valve which is driven via an expansion material and reacts to the coolant temperature. Motor-driven mixing valves have also been described.

U.S. Pat. No. 4,930,455 presents a butterfly valve which is controlled via an electric motor, for use in a motor vehicle. This butterfly valve regulates the relative volumetric flow through the cooling circuit as a function of an electrical control signal which is derived from the coolant temperature in the case described.

U.S. Pat. No. 5,950,576 describes a proportional coolant valve, the valve body of which is disc-shaped in design and includes a plurality of passages which make it possible to establish the desired connections between the inlet channel of the valve and a plurality of outlet channels. The disc-type valve body described in U.S. Pat. No. 5,950,576 is adjusted using a shaft via an electromechanical actuator in accordance with the requirements of an internal combustion engine electronic control unit.

### DISCLOSURE OF THE INVENTION

The valve according to the present invention for controlling volumetric flows in a heating and/or cooling system of a motor vehicle includes a valve housing having at least one inlet channel and at least one outlet channel. At least one disc-type valve body is situated in the valve housing in such a manner that it may rotate about the axis of a shaft, the valve body switching the connection between the at least one inlet channel and the at least one outlet channel of the valve.

According to the present invention, it is provided that the valve includes means for imbalance compensation, which make it possible, in particular, to realize the most even mass distribution of the valve actuating elements possible. The even distribution of mass reduces the load placed on the bearing and transmission that occurs when the valve is shaken. Acceleration values of several “g”s may act on a valve for controlling volumetric flows in a heating and/or cooling system of a motor vehicle. A valve, in particular the valve elements to be actuated, should therefore be balanced, if possible, so that the residual imbalance is as low as possible. In this manner, an inherently dynamic displacement of the valve, in particular an inherently dynamic displacement of the valve body, is advantageously prevented.

Advantageous developments of the valve according to the present invention are possible due to the features listed in the dependent claims.

The means for imbalance compensation of the valve according to the present invention are advantageously located on or in the valve body. Due to the large radial expansion of a disc-type valve body relative to the valve body-displacing shaft and the short switching times of the valve to be realized, the means for imbalance compensation are advantageously located on or in the valve body. To realize an even mass distribution around the rotational and/or bearing axis of the valve body, one or more mass-balancing contours are formed on or in the valve body, in particular in the support regions of the disc-type valve body.

These mass-balancing contours, which are used to reduce an imbalance that occurs when the disc-type valve body performs a rotational motion, may be formed, e.g. via material removal or by depositing material directly on the side or top of the valve disc.

In an advantageous embodiment of the valve according to the present invention, the means for imbalance compensation are designed as at least one passage in the valve disc. Due to the flat design of the valve disc, which is used as a control disc for the fluid volumetric flow through the valve, the mass-balancing contour may be advantageously designed as an open or closed, two-dimensional opening in the control disc.

Via these additional openings in the valve body, the effect of different-sized openings of the control contours may be cushioned, thereby advantageously resulting in the most even mass distribution possible of the control disc about the rotational and/or bearing axis.

Advantageously, the disc-type valve body is situated essentially perpendicularly to the shaft, the mass-balancing contour of the valve body being located eccentrically relative to the shaft which actuates the control disc, in order to influence the moment of inertia, as desired.

The disc-type valve body of the valve according to the present invention is advantageously moved by a servo drive which includes, in particular, at least one electric motor, in particular an electronically commutated electric motor, thereby making it possible—in combination with the control contour of the control disc—to attain a desired opening characteristic of the valve.

The valve according to the present invention is suited, in particular, for use as a coolant control valve of an internal combustion engine. With the aid of one or more valves of this type, it is advantageously possible to realize a heating and/or cooling circuit of a motor vehicle, in the case of which the cooling output requirement may be adapted to the performance level required by the combustion process, and, in particular, independently of the cooling system state.

Further advantages of the valve according to the present invention, and/or of a heating and/or cooling circuit of a motor vehicle that is equipped with a valve of this type result from the description, below, of an embodiment.

### BRIEF DESCRIPTION OF THE DRAWINGS

An embodiment of the valve according to the present invention, and of a heating and/or cooling circuit of a motor vehicle are depicted in the drawing, and they are described in greater detail in the description that follows. The figures in the drawing, their descriptions, and the claims contain numerous features in combination. Those skilled in the art will also consider the features individually and combine them to form further reasonable combinations.

FIG. 1 shows a first embodiment of a valve according to the present invention, in an overview illustration,

FIG. 2 shows the valve in FIG. 1, in a sectional view,

FIG. 3 shows a top view of a control disk of a valve according to the present invention,

FIG. 4 shows an example of a heating and/or cooling circuit of a motor vehicle having a valve according to the present invention.

### DESCRIPTION OF THE EXEMPLARY EMBODIMENTS

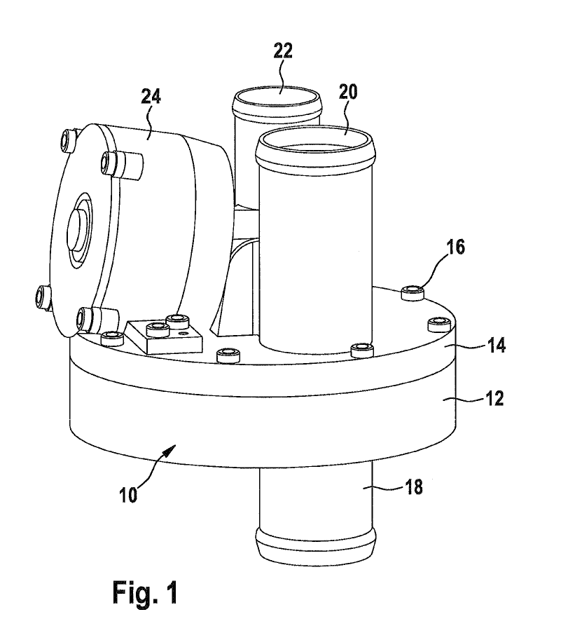

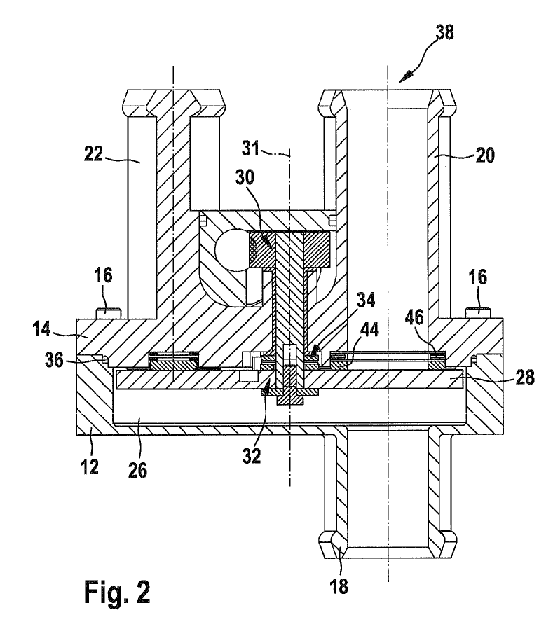

FIG. 1 shows an example of a valve according to the present invention, in an overview illustration. The valve according to the present invention and as embodied in FIG. 1 includes a housing 10 with a housing lower part 12 and a housing upper part 14, which are connected to one another in a fluid-tight manner via connecting means 16, e.g. screws, rivets, or detent means. Housing lower part 12 in particular is designed essentially pot-shaped, as shown in FIG. 2 in particular, thereby making it possible to form a valve chamber in its interior for receiving a valve element. Housing upper part 14 may also be pot-shaped in design, or it may merely be designed as a type of cover in housing lower part 12. Connector 18 of an inlet channel is integrally formed with housing lower part 12. The inlet channel or connector 18 may be formed, in particular, as a single piece with the housing lower part, e.g. in plastic.

A first outlet channel 20 and a second outlet channel 22 are connected to the housing upper part. With the aid of a valve element located in the valve chamber and a valve element to be described in greater detail below, a connection between the inlet channel and the first outlet channel, or between the inlet channel and the second outlet channel may be opened, closed, and varied in a desired manner.

The valve according to the present invention also includes a servo drive 24 for adjusting the valve element.

FIG. 2 shows a cross section through the valve according to the present invention, which extends approximately perpendicularly to the plane of the drawing of FIG. 1.

A disc-type valve body 28 is located in valve chamber 26 formed between housing lower part 12 and housing upper part 14. An output shaft 30 of servo drive 24 which is not depicted in FIG. 2 engages in a central opening of disc-type valve body 28. The valve body is non-rotatably attached to output shaft 30 via appropriate securing means 34. Output shaft 30 is therefore also used as a drive shaft of the valve body. The valve body may be attached to the shaft, e.g. via a threaded connection or a detent connection as depicted in FIG. 2, or by pressing drive shaft 30 into central opening 32 of the valve body.

Sealing means, e.g. a sealing ring 36, are provided between housing lower part 12 and housing upper part 14 to ensure a fluid-tight connection between the two housing parts and valve housing 10. In the embodiment shown in FIGS. 1 and 2, inlet channel 18 is aligned with first outlet channel 20 along a common axis 38.

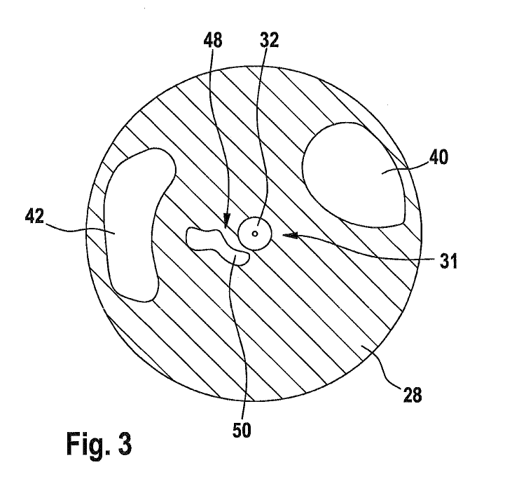

The valve body, which is shown in detail in FIG. 3, includes central opening 32 for receiving or fastening the drive shaft, and control contours 40 and 42—which are designed as passages—for the first and second outlet channels. Depending on the rotational position of valve body 26, control contours 40 and 42 expose a more or less large cross section of the first or second outlet channel. A fluid that is flowing through inlet channel 18 therefore arrives—via valve chamber 26 and control contour 40—at first outlet channel 20, or at second outlet channel 22 via control contour 42.

The valve interior and, in particular, the first and second outlet channels, are sealed via a hydrodynamic seal between two sliding partners which are rotating toward one another in combination with a hydrostatic preload. As a result, the leakage rates are nearly zero when the cooling circuit is closed. For this purpose, the valve according to the present invention includes sealing elements 44 which are spring-loaded against the control element, i.e. valve body 26. Sealing elements 44, which are designed as sealing rings and are shown in FIG. 2 only in first outlet channel 20, are pressed against the valve body via spring elements 46, which may also be realized, e.g. as annular springs, thereby sealing the valve body off from the housing interior.

Advantageously, valve body 28 and sealing elements 44 are composed of material having the same or a comparable hardness, to prevent these elements from wearing, or to at least minimize the wear. At the least, it should be ensured that the two rubbing elements wear evenly. A ceramic-bronze combination is definitely possible, for example. Advantageously, the disc-type valve body may be composed of plastic or a ceramic material. Other materials, such as coated or alloyed metals or steels or comparable compounds are also possible.

According to the present invention, the disc-shaped valve body of the valve includes control contours 40 and 42 for the first and second outlet channel, the central opening for the drive shaft, and a further passage 50 which is used as a mass-balancing element for imbalance compensation of disc-type valve body 28 which is rotatable about axis 31 of drive shaft 30. Imbalance compensation opening 50 is used to realize the most even mass distribution possible of the valve disc about rotational or bearing axis 31. Mass-balancing contour 48 is advantageously formed in the support regions of the control disc. This limits the imbalance that occurs during the rotational motion of the control disc without requiring that a change be made to the opening characteristic of the valve according to the present invention. Via the even distribution of mass which results according to the present invention, the load placed on the bearing and transmission of the valve according to the present invention is markedly reduced in particular when the valve is shaken. The valve according to the present invention for controlling volumetric flows in a heating and/or cooling system of a motor vehicle, which is therefore a coolant control valve of an internal combustion engine, is exposed to the stresses of street traffic, and, as a result, the valve is subject to considerable loads. The design of this coolant control valve of an internal combustion engine as a control valve having a considerable radial expansion of the valve body results in increased requirements in terms of imbalance compensation. Finally, due to the required rapid switching times of a valve of this type and the loads resulting from the use in a motor vehicle, the valve and, in particular, the disc-type valve body, are subject to accelerations of several “g”s. As a result, an even mass distribution of the valve body and, therefore, imbalance compensation are absolutely necessary to ensure smooth operation of a valve of this type. Via the use of a mass-balancing contour in the disc-type valve body according to the present invention, it is possible, in particular, to at least largely rule out an inherently dynamic displacement of the control disc, if not to prevent it completely.

Advantageously, the valve according to the present invention, or the disc-type valve body of this valve includes a mass-balancing contour 48 having a closed boundary line, the mass-balancing contour being designed asymmetrical to axis 31 of drive shaft 30. Basically, however, the means for imbalance compensation of disc-type valve body 28 may have any other type of design. The means for imbalance compensation 48 may also be realized basically via material removal or material deposits, in particular on the valve disc. In an embodiment according to FIG. 2, it is particularly advantageous to deposit material on the side of the valve disc facing inlet channel 18.

The imbalance compensation means may also be realized by depositing material on the circumference of the disc-type valve body.

In addition to the embodiment of an individual mass-balancing contour 48 for the disc-type valve body shown in FIG. 3, it is also possible to use—in other embodiments of the valve according to the present invention—a plurality of mass-balancing contours 48 which are separated from one another.

To realize the most even mass distribution possible about rotational axis 31 of disc-type valve body 28, it is advantageous to use quantitative mass removal and the exact contour shape of the mass-balancing contour or contours 48 to attain imbalance compensation of the control disc. The possibility of using a two-dimensional mass-balancing contour 48 ensures—depending on the particular shape of control contours 40 and 42 of the valve according to the present invention—that imbalance compensation is optimized.

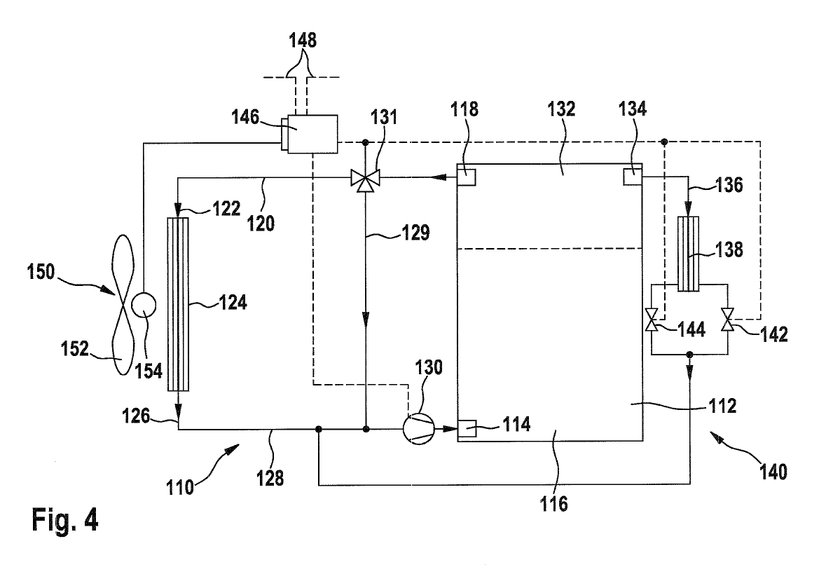

FIG. 4 shows, in a simplified, schematic depiction, a cooling and heating circuit 110 for cooling an internal combustion engine 112 having a coolant control valve 131 according to the present invention. Internal combustion engine 112 includes a first coolant inlet 114 in the region of its engine block 116, and a first coolant outlet 118, via which an inlet line 120 and a radiator inlet 122 are connected to a radiator 124 of coolant circuit 110. Radiator 124 is connected via a radiator outlet 126 and a connecting line 128 to coolant inlet 114 of internal combustion engine 112.

A coolant pump 130 is located in connecting line 128 in order to pump the coolant through cooling circuit 110 of internal combustion engine 112. In the embodiment depicted in FIG. 4, coolant pump 130 is electronically controlled. Purely mechanical coolant pumps are also possible in other embodiments for a cooling and heating circuit according to the present invention.

A second coolant outlet 134 is located in the region of cylinder head 132 of Internal combustion engine 112. Coolant outlet 134 is connected via a connecting line 136 to a heat exchanger 138 of a heating branch 140. A portion of the warmed coolant exiting engine 112 is used in heating branch 140 to utilize, via heat exchanger 138, the heat energy stored in the hot coolant for heating purposes, e.g. to heat a passenger compartment which is not depicted in FIG. 4. The regulation of the heating function according to need is indicated schematically in FIG. 4 via controlled heating valves 142 and 144.

A bypass line 129 branches off from return line 120 of cooling and heating circuit 110, extends parallel to radiator element 124, and connects return line 120 directly to connecting line 128 between radiator outlet 126 and radiator inlet 114 of the engine. To regulate the relative volumetric flows through radiator element 124 and bypass line 129, a three-way bypass valve 131 is provided in the embodiment shown of a cooling circuit and heating circuit according to FIG. 4, three-way bypass valve 131 being controlled and regulated by a control device 146. Bypass valve 131 is designed as the type of valve according to the present invention and which is depicted in FIGS. 1 through 3.

In the embodiment of cooling and heating circuit 110 depicted in FIG. 4, heating valves 142 and 144 of heating branch 140 are also controlled and regulated via control device 146, as is bypass valve 131. Control device 146, which may also be, e.g. the engine control unit of the motor vehicle, is connected to various sensors which are not shown in FIG. 4, for simplicity, and which are merely indicated via electrical connecting lines 148. Via these sensors, current parameters of the cooling circuit or the engine are sent to control device 146, where they may be compared with data stored in the control device in order to ascertain correcting variables for the active components of the cooling and heating circuit 110. In addition to the parameters of cooling circuit 110, e.g. coolant temperature, the engine temperature, and, in particular, the engine temperature at various temperature-critical points in the engine are transmitted to control device 146. As further input signals for the control device, it is also possible to transmit the fuel consumption, pollutant emissions of the internal combustion engine, the engine speed, torque, and outside temperature to the control device via appropriate sensors.

In the embodiment depicted in FIG. 4, control device 146 is also used to control a cooling fan 150 as needed. Cooling fan 150 is assigned to radiator 124 of the cooling circuit in order to increase the cooling output of the cooling system. Cooling fan 150 is composed of a fan 152 and a motor 154 which drives the fan. Motor 154 receives its control data and power supply from control device 146 via appropriate electrical connecting lines Control device 146 also regulates the output of electrical coolant pump 130.

In particular, control device 146 calculates one correcting variable each for the actuators of valves 131, 142, and 144, and further valves which are not shown in the simplified depiction of a cooling circuit according to FIG. 4, in order to regulate the current actual engine temperature to an optimal engine setpoint temperature. The triggering of the actuators of the valves—according to the present invention—of cooling and heating circuit 110 takes place in a manner such that the volumetric flow regulated by the valves is as linear-proportional as possible to the correcting variable for the particular actuator. In this manner, the valves may be adjusted exactly according to the requirements of the control device, thereby making it possible to adapt the coolant volumetric flow very exactly to the requirements, e.g. of a time-dependent temperature model for the engine that is stored in control unit 146. To set the optimal engine temperature, the relative coolant volumetric flow through radiator 124 and bypass line 129 is regulated using the controllable valve according to the present invention. For example, in the start-up phase of engine 112, connecting line 120 to engine radiator 124 may be closed completely, and bypass valve 131 according to the present invention may be opened in the direction of bypass line 129, either completely or slightly. In this manner, it is possible to reach the optimal working temperature of engine 112 rapidly, thereby making it possible to attain the operating conditions of low fuel consumption and low pollutant emissions of the engine at an early point. Once the optimal engine temperature has been reached, radiator supply line 120 is opened by bypass valve 131, and bypass line 129 may be closed accordingly so that the excess heat energy produced by engine 112 may be dissipated to the surroundings via radiator element 124 and cooling fan 150. It is also possible to completely close bypass line 129 and the supply line to the radiator via bypass valve 131 simultaneously.

The valve according to the present invention is not limited to the embodiments depicted in the description.

In particular, the valve according to the present invention is not limited to the use of just one valve body.

What is claimed is:

1. A valve for controlling volumetric flows in a heating and/or cooling system of a motor vehicle, comprising a valve housing (10), away from which at least one inlet channel (18) and at least one outlet channel (20, 22) branch, and comprising at least one disc-type valve body (28) which is located in the valve housing (10) in a manner such that it may rotate about the axis (31) of a shaft (30),
wherein
the valve includes means (48, 50) for imbalance compensation.

2. The valve as recited in claim 1,
wherein
the means for imbalance compensation (48, 50) are located eccentrically to the shaft (30).

3. The valve as recited in claim 1,
wherein
the means for imbalance compensation (48, 50) are located on or in the valve body (28).

4. The valve as recited in claim 3,
wherein
the means for imbalance compensation (48, 50) include one or more mass-balancing contours (48) of the valve disc (28).

5. The valve as recited in claim 3,
wherein
the at least one mass-balancing contour (48) has a closed boundary line.

6. The valve as recited in claim 3,
wherein
the means for imbalance compensation (48, 50) are designed as a material deposit on the valve disc (28).

7. The valve as recited in claim 3,
wherein
the means for imbalance compensation (48, 50) are designed as at least one passage (50) in the valve disc (28).

8. The method as recited in claim 1,
wherein
the disc-type valve body (28) is located essentially perpendicular to the shaft (30).

9. The valve as recited in claim 1,
wherein
the shaft (30) of the at least one valve body (28) is moveable using a servo drive (24).

10. The valve as recited in claim 1,
wherein
the servo drive (24) includes at least one electric motor, in particular an electronically commutated electric motor.

11. The valve as recited in claim 1,
wherein
the valve housing (10) includes a second outlet channel (22) which is connectable to the inlet channel (18) via the valve element (28).

12. A coolant control valve (131) of an internal combustion engine as recited in claim 1.

13. A heating and/or cooling circuit of a motor vehicle comprising at least one valve (131) as recited in claim 1.
